(19) United States
(12) Patent Application Publication
(10) Pub. No.: US 2022/0075460 A1
(43) Pub. Date: Mar. 10, 2022

(54) THIGH-SUPPORTABLE MOUSE PAD DEVICE FOR SUPPORTING A MOUSE, TABLET OR OTHER ELECTRONIC DEVICE

(71) Applicant: Arie Berkovitz, Davie, FL (US)

(72) Inventor: Arie Berkovitz, Davie, FL (US)

(21) Appl. No.: 17/469,275

(22) Filed: Sep. 8, 2021

Related U.S. Application Data
(60) Provisional application No. 63/075,977, filed on Sep. 9, 2020.

(51) Int. Cl. G06F 3/039; A47B 23/00; A47B 21/04

(52) U.S. Cl. CPC G06F 3/0395; A47B 21/04; A47B 23/002

(57) ABSTRACT

A thigh-supportable mouse pad device is provided, which is attachable to a thigh of a user to support a computer mouse, tablet or other personal mobile electronic device in a comfortable position for the user. The thigh-supportable mouse pad device includes a mouse pad assembly having a top surface which supports a computer mouse and the computer mouse to operate thereon. The mouse pad device further includes a pad support configured to secure the mouse pad assembly on the thigh of the user. The mouse pad assembly may be rotatable and/or tiltable relative to the thigh, to accommodate different user postures and electronic devices, and provide a variety of uses and applications.

### CROSS-REFERENCE TO RELATED APPLICATIONS

This application claims the benefit of U.S. Provisional Patent Application Ser. No. 63/075,977, filed on Sep. 9, 2020, which is incorporated herein in its entirety.

### FIELD OF THE INVENTION

The present invention relates generally to mouse pads, and more particularly, to a thigh-supportable mouse pad device that can be attached to a thigh of a user to support a computer mouse, tablet or other personal mobile electronic device in a comfortable position for the user.

### BACKGROUND OF THE INVENTION

Personal computers are nearly ubiquitous throughout the world. In their work lives, many persons use a computer while sitting at a desk in an office. Furthermore, most people in the United States and in other industrialized parts of the world use personal computers for accessing the Internet, writing and sending emails or playing video games.

In recent years, personal computers have become progressively smaller, with enhanced portability, while their speed and computational power have increased. Advances in battery technology have enabled computers to operate for hours without connection to an external energy supply. Easy-to-use operating systems have been developed, particularly for tablets. Accordingly, laptop computers and tablet computers have increased in popularity over the years.

Personal computers, laptop computers, tablets and other electronic devices may include a handheld, manually-movable pointing device, commonly referred to as mouse, which controls movement of a cursor on the display of the computer or device. A conventional computer mouse includes a convex or other ergonomic housing configured to be comfortably held by a user's hand. The mouse further includes a mechanism or device configured to track movement of the mouse along a surface. For instance, a mechanical mouse typically includes a bottom opening formed in the housing, through which a rubber or plastic roller partially protrudes, wherein rotation of the roller is sensed and tracked. In another example, optical and laser mice are known, which typically comprise a light-emitting device configured to detect movement relative to the surface along which the mouse is displaced. The computer mouse may be connected via a cord, wire or wireless interface to the computer or device. As the computer mouse is moved on a flat operating surface, the movements of the roller or the information produced by the light-emitting device are transmitted to a controller, which imparts the corresponding two-dimensional movements to the cursor on the display. Left and right mouse buttons on the computer mouse may enable the user of the computer or device to carry out various functions with respect to the mouse and graphics and items shown on the display.

In usual practice, the computer mouse may optionally be operated on a mouse pad which lies on a horizontal surface adjacent to the computer keyboard. The mouse pad provides a smooth and resilient surface which the roller of the mouse traverses during use of the computer mouse.

In some applications, the operating surface on which a computer mouse is placed and moved is typically an elevated surface on a desktop or workstation. The computer or device user typically uses one hand to grasp and move the mouse as well as depress the left and right mouse buttons. Prolonged implementation of these movements may result in repetitive stress movements such as carpel tunnel syndrome and tendonitis. In many cases, the user must hold the mouse-operating arm and hand in an elevated position which may be uncomfortable for the user and may contribute to fatigue and repetitive stress of the arm, wrist and hand.

Accordingly, there remains a need for a solution to at least one of the aforementioned problems. Particularly, there remains a need for a more ergonomic placement of a computer mouse.

### SUMMARY OF THE INVENTION

The present invention is directed to a thigh-supportable mouse pad device which can be attached to a thigh of a user to support a computer mouse, tablet or other personal mobile electronic device in a comfortable position for the user. An illustrative embodiment of the thigh-supportable mouse pad device may include a pad support and a mouse pad assembly. The mouse pad assembly may be provided on the pad support, and may be secured to the thigh of the user by the pad support. The mouse pad assembly comprises a top surface, and is suitably configured to support a computer mouse as an operator of the mobile personal electronic device operates the mouse along the top surface, or to support a mobile personal electronic device on the top surface as the user operates the device.

In a second aspect, at least one logo, image, pattern, design, text, number, and/or other informative and/or decorative element may be provided on the top surface of the mouse pad assembly.

In another aspect, a pad base assembly may be provided on the pad support, and the mouse pad assembly may be supported by the pad base assembly.

In another aspect, the pad base assembly may include a bottom base plate and a top base plate which may be rotatable with respect to the bottom base plate.

In another aspect, the pad support may include at least one fastening strap configured to wrap around and attach to the user's thigh.

In another aspect, each fastening strap of the pad support may include at least one flexible material such as plastic, silicone, rubber and/or plastic.

In another aspect, a connecting portion may connect the fastening strap or straps of the pad support, and the bottom base plate of the pad base assembly may be supported by the connecting portion.

In another aspect, the top base plate may magnetically engage the bottom base plate of the pad base assembly for indexed rotation of the mouse pad assembly with respect to the pad support.

In another aspect, the mouse pad assembly may be deployable at a selected sloped angle with respect to the pad support.

In another aspect, a hinge may pivotally attach the mouse pad assembly to the pad base assembly.

In another aspect, the mouse pad assembly may include a bottom pad plate and a middle pad plate, and the mouse support layer may be provided on the middle pad plate.

In another aspect, the bottom panel plate of the mouse pad assembly may include a rigid panel of ABS plastic.

In another aspect, the middle panel plate of the mouse pad assembly may include a ferromagnetic layer.

In another aspect, the mouse support layer of the mouse pad assembly may include a cloth, fabric, rubber or other skin-friendly material.

In another aspect, a protuberance may be provided at or adjacent to an edge of the mouse support layer.

In another aspect, the protuberance may include a foam material.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a top front isometric view of a thigh-supportable mouse pad device according to an illustrative embodiment of the present invention;

FIG. 2 presents an exploded top isometric view of the thigh-supportable mouse pad device illustrated in FIG. 1;

FIG. 3 presents an exploded bottom isometric view of the thigh-supportable mouse pad device illustrated in FIG. 1;

FIG. 4 presents a top front isometric view of the illustrative thigh-supportable mouse pad device, more particularly illustrating rotational capability of the mouse pad assembly according to some embodiments;

FIG. 5 presents a side view of the illustrative thigh-supportable mouse pad device, more particularly illustrating angular positioning capability of the mouse pad assembly according to some embodiments;

FIG. 6 presents a top rear isometric view of the thigh-supportable mouse pad device illustrated in FIG. 5, with the mouse pad assembly deployed in the angled position;

FIG. 7 presents a bottom rear isometric view of the thigh-supportable mouse pad device illustrated in FIG. 5, with the mouse pad assembly deployed in the angled position;

FIG. 8 presents an isometric view of the illustrative thigh-supportable mouse pad, deployed in place on the thigh of a user, more particularly illustrating typical placement of a computer mouse on the mouse pad assembly in typical application of the thigh-supportable mouse pad device;

FIG. 9 presents an isometric view of the illustrative thigh-supportable mouse pad device, deployed in place on the thigh of a user, with a mobile personal electronic device placed on the mouse pad assembly in typical application of the thigh-supportable mouse pad device;

FIG. 10 presents a top front isometric view of a thigh-supportable mouse pad device according to a secondary illustrative embodiment of the present invention;

FIG. 11 presents a top rear isometric view of the thigh-supportable mouse pad device illustrated in FIG. 10, with the mouse pad assembly deployed in the angled position;

FIG. 12 presents a secondary top rear isometric view of the thigh-supportable mouse pad device illustrated in FIG. 10, with the mouse pad assembly deployed in the angled position;

FIG. 13 presents a bottom rear isometric view of the thigh-supportable mouse pad device illustrated in FIG. 10, with the mouse pad assembly deployed in the angled position; and

FIG. 14 presents a top front isometric view of the thigh-supportable mouse pad device illustrated in FIG. 10, with removable fastening straps.

Like reference numerals refer to like parts throughout the several views of the drawings.

### DETAILED DESCRIPTION

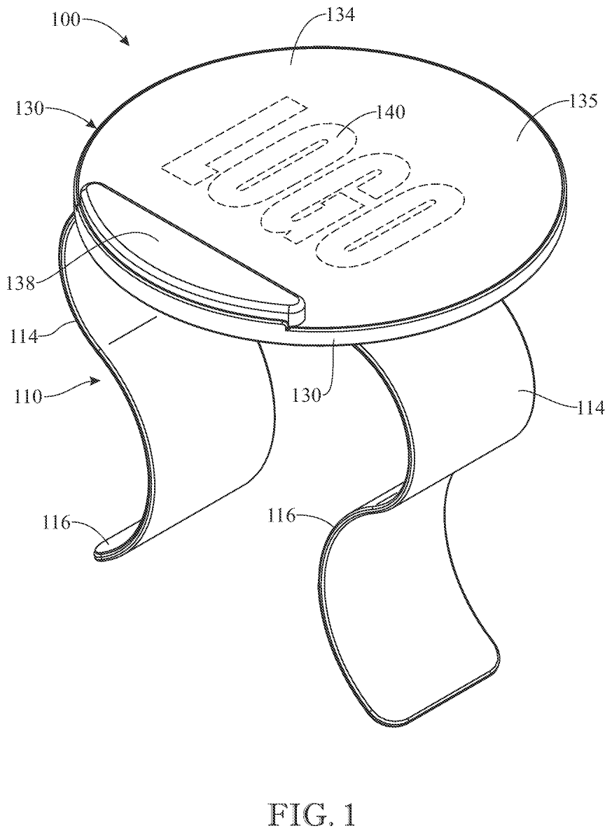

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a thigh-supportable mouse pad device that can be attached to a thigh of a user to support a computer mouse, tablet or other personal mobile electronic device in a comfortable position for the user.

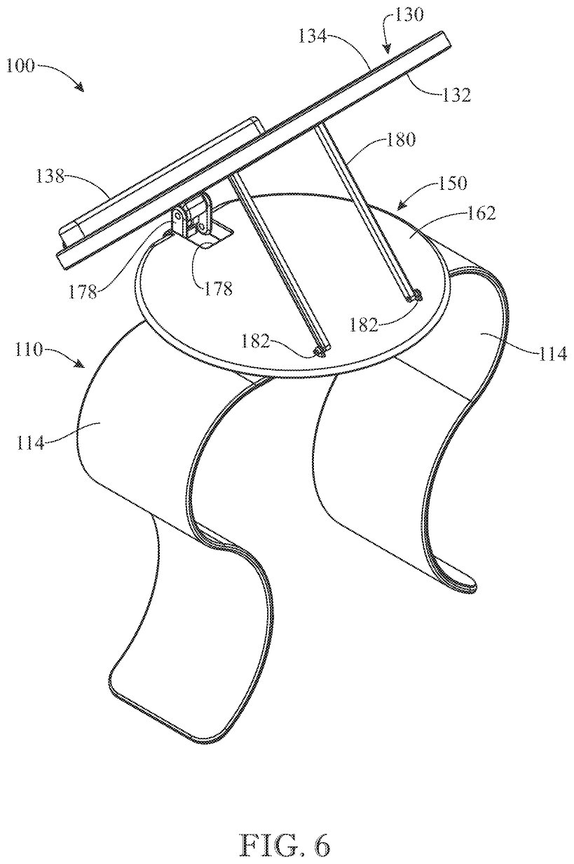

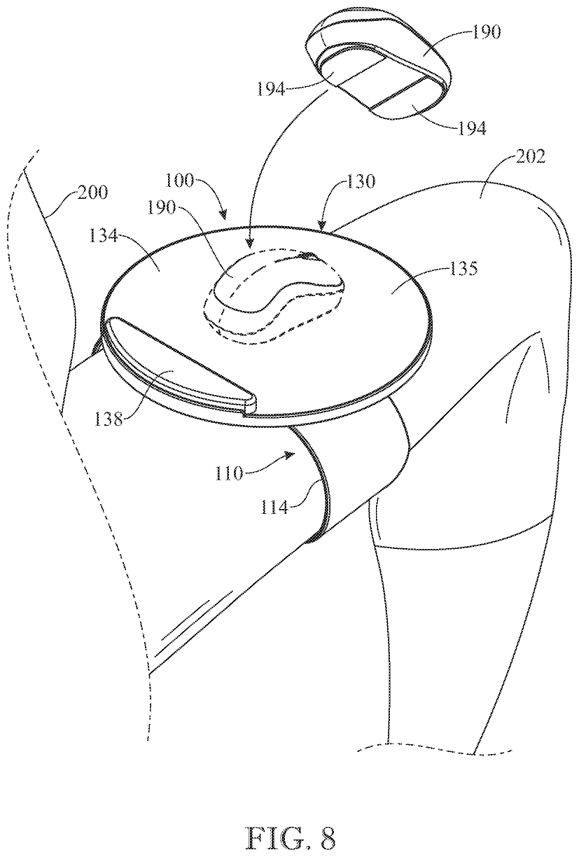

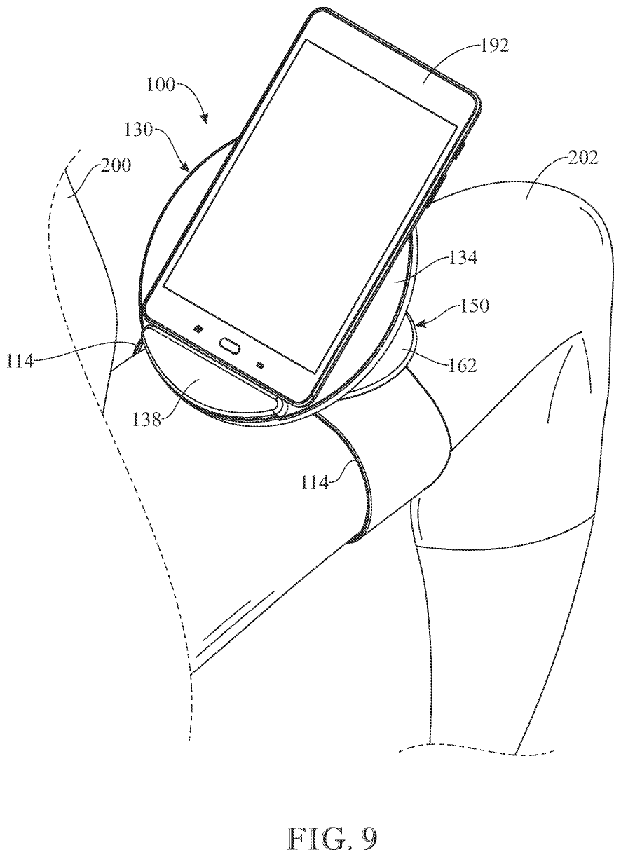

The illustrations of FIGS. 1-9 show a thigh-supportable mouse pad device, hereinafter referred to as mouse pad device 100, in accordance with an exemplary embodiment of the present invention. Referring initially to FIG. 1, the mouse pad device 100 may include a pad support 110 and a mouse pad assembly 130. The pad support 110 may be configured to securely engage a thigh 202 of a user 200, as illustrated in FIGS. 8 and 9. The mouse pad assembly 130 may be supported by the pad support 110, and thereby supported by the user's thigh 202, as will be hereinafter described.

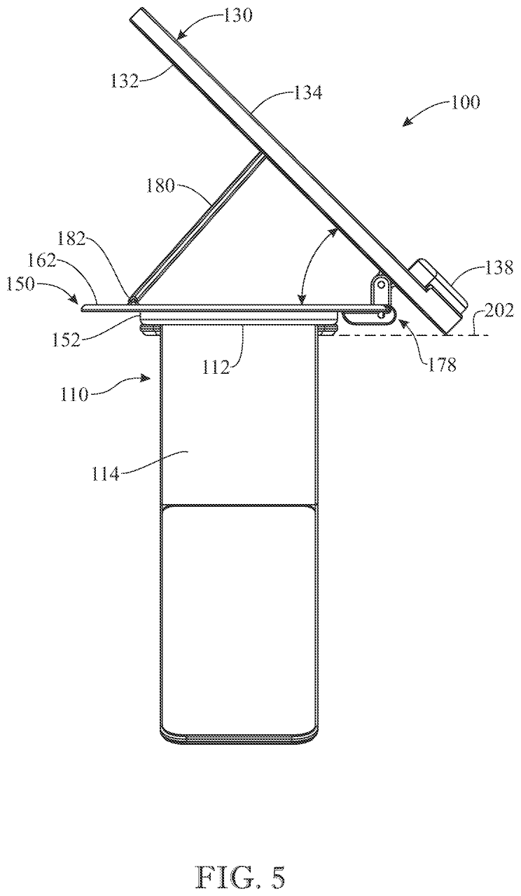

As illustrated in FIG. 8 and will be hereinafter described, the mouse pad assembly 130 may be suitably configured to support a computer mouse 190 for manipulation and operation by a user in some applications of the mouse pad device 100. Furthermore, in some embodiments, as illustrated in FIG. 9 and will be hereinafter described, the mouse pad assembly 130 may be configured to support a mobile personal electronic device 192 in some applications of the mouse pad device 100. As illustrated in FIGS. 5-7 and as will be described in greater detail hereinafter, in some embodiments, the mouse pad assembly 130 of the mouse pad device 100 may be selectively deployable at a selected sloped angle with respect to the pad support 110. The user of the mouse pad device 100 can deploy the mouse pad assembly 130 at the selected angle to achieve optimum ergonomic comfort for the user in dependence of the user's desired body posture.

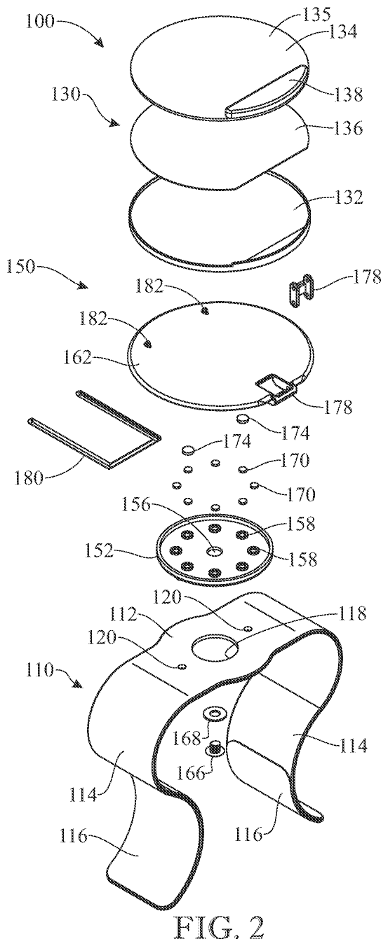

The pad support 110 of the mouse pad device 100 may have any design which is suitable for the purpose of securely engaging the thigh 202 of the user 200 and supporting the mouse pad assembly 130 on the user's thigh 202. Accordingly, in some embodiments, the pad support 110 may include a central, connecting portion 112 (FIG. 2). One or more elongated, spaced-apart fastening straps 114 may extend from the connecting portion 112 and may be configured to wrap around the user's thigh 202. The one or more fastening straps 114 may include a pair of flexible straps, as shown. The fastening strap or straps 114 may be fabricated of a flexible material such as plastic, silicone, rubber and/or plastic, for example and without limitation. In the present embodiment, each fastening strap 114 extends from the corresponding end of the connecting portion 112 of the pad support 110. The pad support 110 may be deployed in place on the user's thigh 202 by placing the pad support 110 over the thigh 202 as the connecting portion 112 of the pad support 110 rests on the user's thigh 202. The mouse pad assembly 130 may be mounted on the connecting portion 112 of the pad support 110 as will be hereinafter described.

As illustrated in FIGS. 1-4, at least one strap fastener 116 may be provided on the interior surfaces of the fastening straps 114, respectively. The strap fasteners 116 may facilitate fastening of the fastening straps 114 around the thigh 202 of the user 200. In some embodiments, the strap fasteners 116 may include hook-and-loop fasteners, as shown, for example and without limitation. Other types of strap fasteners 116 which may be suitable for the purpose include, but are not limited to, magnets, buttons, snap fasteners, and adhesives.

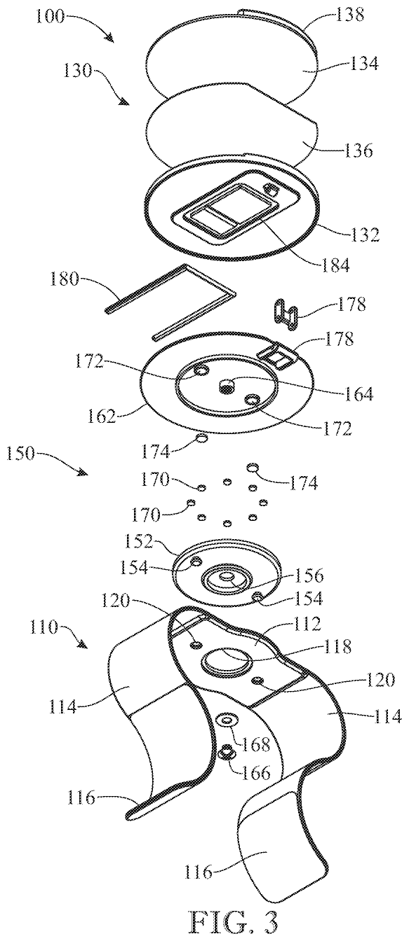

As mentioned heretofore, the pad support 110 carries the mouse pad assembly 130 of the mouse pad device 100. As illustrated in FIGS. 2 and 3, in some embodiments, the mouse pad assembly 130 may include a bottom pad plate 132. A mouse support layer 134 may be provided on and carried by the bottom pad plate 132. The bottom pad plate 132 of the mouse pad assembly 130 may have a rigid panel construction, thereby providing rigidity and mechanical resistance to the mouse pad assembly 130; for example and without limitation, in some embodiments, the bottom pad plate 132 may be made of, or include, ABS plastic. In turn, the mouse support layer 134 may be made of one or more soft, skin-friendly and mouse-compatible materials such as, but not limited to, cloth, fabric and/or rubber, to allow the mouse to properly function as it is moved along a top surface 135 of the mouse support layer 134. In some embodiments, such as the present embodiment, at least one middle pad plate 136 may be disposed between the bottom pad plate 132 and the mouse support layer 134 for purposes that will be described hereinafter.

In some embodiments, at least one protuberance 138 may be provided on the mouse support layer 134 for purposes which will be hereinafter described. The protuberance 138 may include a foam or foam rubber material, for example and without limitation.

As illustrated in FIG. 1, in some embodiments, at least one logo, image, pattern, design, text, number, and/or other informative and/or decorative element may be provided on the surface of the mouse support layer 134. For example, the present embodiment features a logo 140, which may include, but is not limited to, a logo of an athletic team, business or the like.

As particularly illustrated in FIGS. 2, 3 and 5-7, in some embodiments, a pad base assembly 150 may attach the mouse pad assembly 130 to the pad support 110. The pad base assembly 150 may include a bottom base plate 152. The bottom base plate 152 of the pad base assembly 150 may be supported by the connecting portion 112 of the pad support 110, as will be hereinafter described. A top base plate 162 may be provided on the bottom base plate 152. The bottom pad plate 132 of the mouse pad assembly 130 may be provided on the top base plate 162.

The bottom base plate 152 and the top base plate 162 of the pad base assembly 150 may be attached to the connecting portion 112 of the pad support 110 according to the knowledge of those skilled in the art. Accordingly, as illustrated in FIGS. 2 and 3, in some embodiments, a plate mount opening 118 may extend through the connecting portion 112. At least one, and more preferably, a pair of tab openings 120 may extend through the connecting portion 112 of the pad support 110. At least one plate mount tab 154 may extend from the underside or bottom surface of the bottom base plate 152 in alignment or registration with the respective tab openings 120 in the connecting portion 112. The bottom base plate 152 may seat into the plate mount opening 118 as the plate mount tabs 154 on the bottom base plate 152 engage the respective tab openings 120 in the connecting portion 112 of the pad support 110.

A central plate attachment opening 156 may extend through the bottom base plate 152. As illustrated in FIG. 3, an interiorly threaded plate mount boss 164 may extend from the underside or bottom surface of the top base plate 162 in alignment or registration with the plate attachment opening 156 of the bottom base plate 152. A plate fastener 166 may extend through a washer 168 and through the plate mount opening 118 in the connecting portion 112 of the pad support 110 and the plate attachment opening 156 in the bottom base plate 152, respectively, and thread into the plate mount boss 164 on the top base plate 162. The top base plate 162 may be selectively rotatable with respect to the bottom base plate 152 and the pad support 110, via the plate fastener 166, for purposes which will be hereinafter described.

As further illustrated in FIGS. 2 and 3, in some embodiments, the top base plate 162 may magnetically engage the bottom base plate 152 of the pad base assembly 150 to magnetically “lock” the top base plate 162 in at least one, and more preferably, multiple different rotational positions relative to the bottom base plate 152. As illustrated in FIG. 2, at least one, and more preferably, multiple bottom plate magnet seats 158 may be provided on the upper surface of the bottom base plate 152. At least one, and more preferably, multiple bottom plate magnets 170 may be provided in the respective bottom plate magnet seats 158. As illustrated in FIG. 3, at least one, and more preferably, a pair of top plate magnet seats 172 may be provided on the lower surface of the top base plate 162. At least one, and more preferably, a pair of top plate magnets 174 may be provided in the respective top plate magnet seats 172. Therefore, the top base plate 162 may be capable of indexed rotation with respect to the bottom base plate 152 of the pad base assembly 150 as the top plate magnets 174 on the top base plate 162 magnetically engage the respective bottom plate magnets 170 on the bottom base plate 152.

As illustrated in FIGS. 5-7, in some embodiments, the mouse pad assembly 130 may be selectively deployable at a sloped angle relative to the pad base assembly 150 and the pad support 110. Accordingly, at least one hinge 178 may pivotally attach the bottom pad plate 132 of the mouse pad assembly 130 to the top base plate 162 of the pad base assembly 150. At least one plate support 180 may selectively support the mouse pad assembly 130 at the selected angle. In some embodiments, the plate support 180 may be U-shaped and may be pivotally attached to the upper surface of the top base plate 162 via at least one support mount flange 182. The plate support 180 may adjustably engage the bottom pad plate 132 of the mouse pad assembly 130 to facilitate deployment of the mouse pad assembly 130 at the selected sloped angle with respect to the pad base assembly 150.

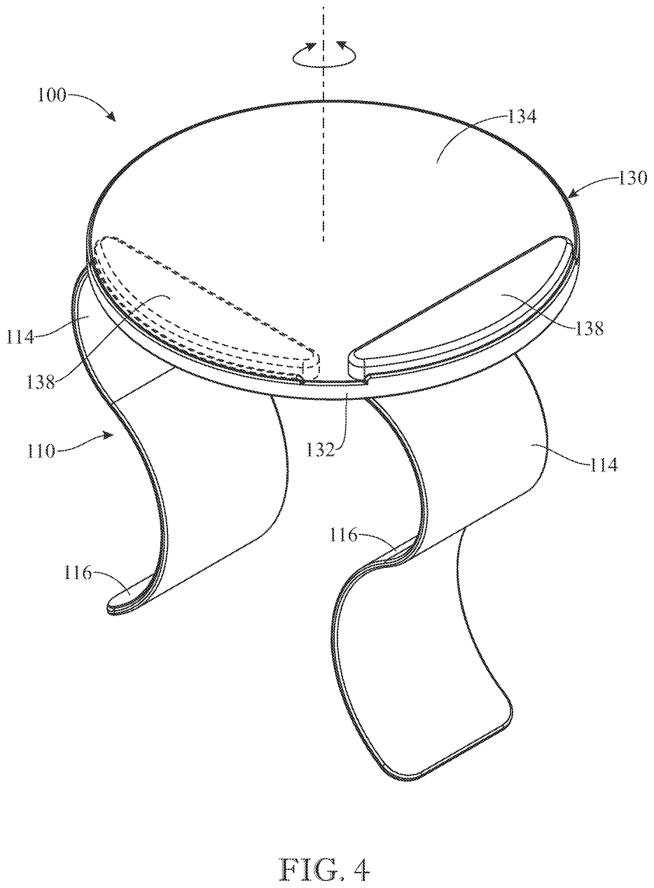

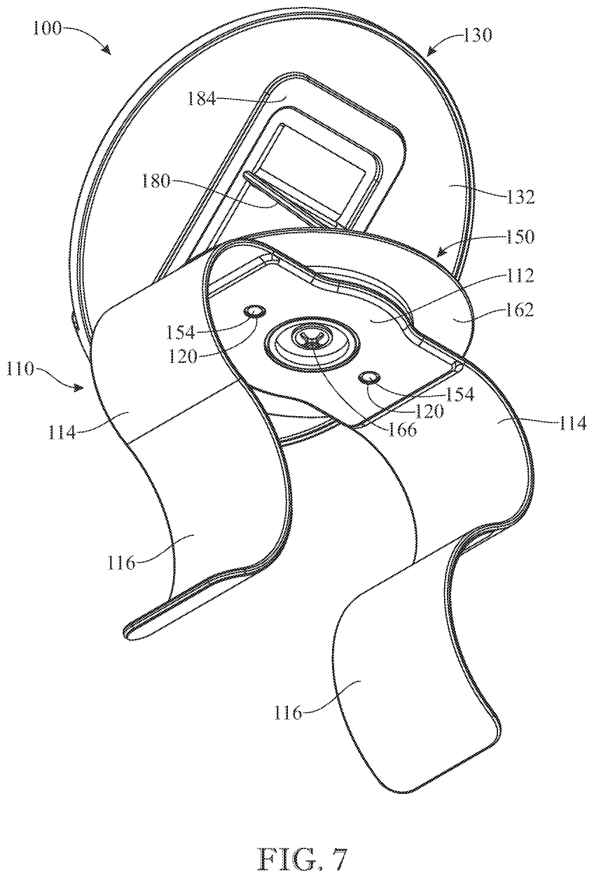

As illustrated in FIGS. 3 and 7, a plate support recess 184 may be provided in the lower surface of the bottom pad plate 132 of the mouse pad assembly 130. The plate support recess 184 may be configured to accommodate the plate support 180 in the lowered position of the mouse pad assembly 130 which is illustrated in FIGS. 1 and 4.

As further illustrated in FIG. 8, in some embodiments, at least one first magnetic member 194 may be provided on or comprised in the computer mouse 190. The one or more first magnetic members 194 may facilitate magnetic attraction between the computer mouse 190 and the mouse pad assembly 130, and thus magnetic attachment between the computer mouse 190 and the mouse pad assembly 130 during application of the mouse pad device 100, as will be hereinafter described. For instance, in some embodiments, the one or more first magnetic members 194 may include one or more magnets, and the middle pad plate 136 of the mouse pad assembly 130 may include or may be made of a ferromagnetic material compatible to magnetically attract to the one or more magnets. Alternatively or additionally, the one or more first magnetic members 194 may include a ferromagnetic material, and the middle pad plate 136 of the mouse pad assembly 130 may include one or more magnets compatible to magnetically attract to the ferromagnetic material. In some embodiments, the one or more first magnetic members 194 of the computer mouse 190 may be internal to and/or otherwise come with or form integral part of the computer mouse 190. In other embodiments, the one or more first magnetic members 194 may be attachable to the computer mouse 190; for example, the one or more first magnetic members 194 may include one or more relatively planar magnets or ferromagnetic parts or sheets, provided with an adhesive material to adhere to the computer mouse 190 (the adhesive material may be initially covered by a peel-off film or layer which may be removed prior to adhering the one or more first magnetic members 194 to the computer mouse 190). In some embodiments, the one or more relatively planar parts, or sheets, may be shaped and sized to conform to an outer shape of an underside of the computer mouse 190 (as shown, for instance, in FIG. 8); alternatively or additionally, the one or more relatively planar parts, or sheets, may be cuttable to allow a user to customize their shape and size to that of an existing computer mouse 190.

As illustrated in FIG. 8, in an example of application, the mouse pad device 100 may be deployed in place on the thigh 202 of a user 200 as the user 200 operates a computer mouse 190 (FIG. 8) or a mobile personal electronic device 192 (FIG. 9). The fastening straps 114 of the pad support 110 may be extended downwardly over the user's thigh 202 as the fastening straps 114 initially flex outwardly and then recoil inwardly in place against the respective sides of the thigh 202. The fastening straps 114 may then be secured to one another by attachment of the strap fasteners 116. The computer mouse 190 may be placed on the mouse support layer 134 of the mouse pad assembly 130. The user 200 may place a hand (not illustrated) on and move the computer mouse 190 as the computer mouse 190 controls movement of a cursor (not illustrated) on the display of a controlled computer or mobile personal electronic device, for example and without limitation. In the event that the computer mouse 190 is provided with one or more first magnetic members 194 and the mouse pad assembly 130 includes a compatible magnetic or ferromagnetic middle pad plate 136 (or other compatible magnetic or ferromagnetic part(s) configured to magnetically attract to the one or more first magnetic members 194), the magnetic attraction force therebetween is configured to be sufficient to prevent the computer mouse 190 from slipping off of the mouse pad assembly 130 in the event of accidental or inadvertent tilting, but is not high enough to cause discomfort or require excessive effort from the user in order to manually slide and operate the computer mouse 190 when the mouse pad assembly 130 is horizontal or approximately horizontal.

As illustrated in FIG. 9, in some applications, the mouse pad device 100 may support a mobile personal electronic device 192 such as a tablet computer or smartphone, for example and without limitation. If desired to increase ease of operation and/or view of the mobile personal electronic device 192, the mouse pad assembly 130 may be rotated with respect to the bottom base plate 152 of the pad base assembly 150 to position the protuberance 138 closer to the user 200, as illustrated in FIG. 8. The mouse pad assembly 130 may be deployed at the selected sloped angle with respect to the pad base assembly 150 and pad support 110 by pivoting the bottom pad plate 132 of the mouse pad assembly 130 with respect to the top base plate 162 of the pad base assembly 150 via the hinge 178 and deploying the plate support 180, as was heretofore described with respect to FIGS. 5-7. As shown, the sloped orientation of the mouse pad assembly 130 may further increase user comfort by allowing the mobile personal electronic device 192 to be supported on and retained by the protuberance 138. It is further understood that other items (e.g., a book, notebook or magazine) may alternatively or additionally supported by the mouse pad assembly 130 and, optionally, the protuberance 138, whether in the horizontal or approximately horizontal position of FIG. 8 or the tilted position of FIG. 9.

As illustrated in FIG. 5, it will be appreciated by those skilled in the art that the hinge 178 may impart a degree of lift to the mouse pad assembly 130 such that the rear edge of the mouse pad assembly 130 does not contact the thigh 202 of the user 200 until the mouse pad assembly 130 reaches a steep angle. This expedient may prevent or reduce friction of the mouse pad assembly 130 against the user's thigh 202, thus enhancing user comfort.

Furthermore, the rotational position of the mouse pad assembly 130 may be adjusted to properly position the protuberance 138 for optimal wrist resting thereon, or optimal support thereon of the mobile personal electronic device 192. This may be accomplished by rotating the top base plate 162 relative to the bottom base plate 152 of the pad base assembly 150 as the mouse pad assembly 130 “clicks” into position by selective magnetic attraction of the top plate magnets 174 on the top base plate 162 relative to the respective bottom plate magnets 170 on the bottom base plate 152 as the mouse pad assembly 130 and top base plate 162 are jointly rotated relative to the bottom base plate 152.

In some embodiments, the mouse pad device 100 may further include a wired or wireless charging unit configured to wired or wirelessly charge one or more electronic devices placed on, near, or used in conjunction with, the mouse pad device 100 (e.g., the computer mouse 190, the tablet or mobile personal electronic device 192, etc.). In some embodiments, the wired or wireless charging device may be located in the mouse pad assembly 130 or the pad base assembly 150. However, alternative locations are contemplated without departing from the scope of the present invention. In order to power the wired or wireless charging unit, the mouse pad device 100 may include a power module comprising one or more rechargeable or non-rechargeable batteries, and/or configured to receive electrical power from an external source (e.g., an electrical wall socket) via an electrical cable.

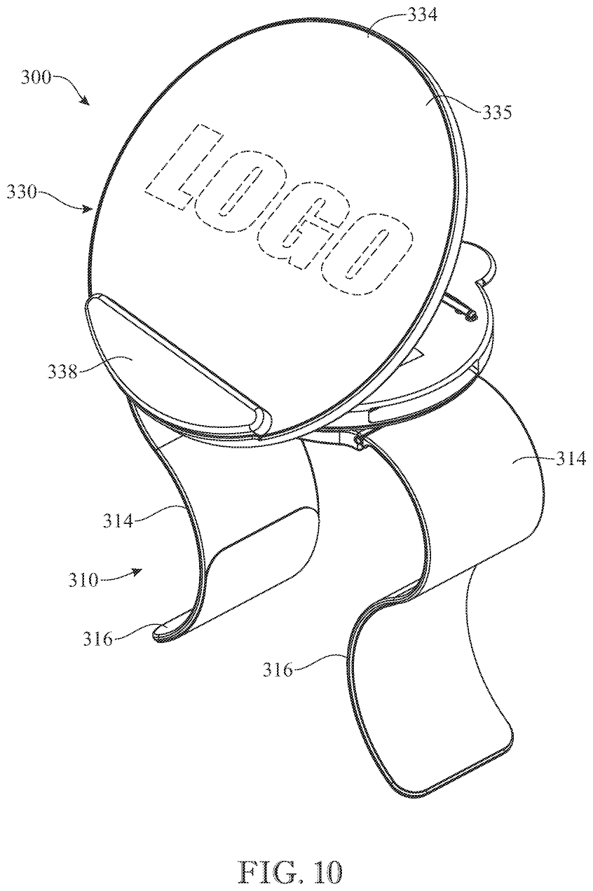

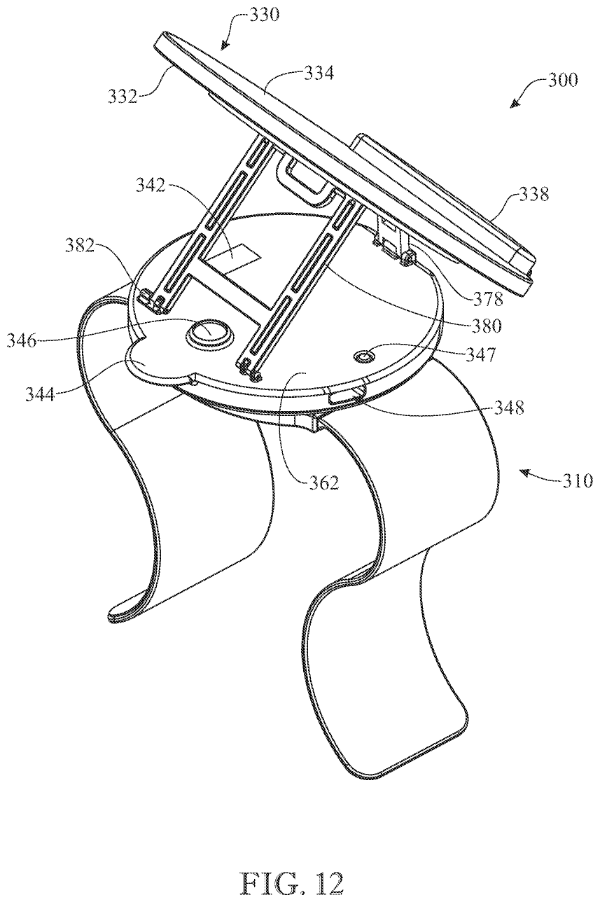

With reference now to FIGS. 10-14, an alternative embodiment of the mouse pad device 300, is shown. Mouse pad 100 and mouse pad 300 include similar features. Therefore, like features and elements of mouse pad 300 are numbered the same as mouse pad 100, however, each number is prefixed by the number ‘3.’ With initial reference to FIGS. 10-12, the mouse pad device 300 may include a pad support 310 and a mouse pad assembly 330. The pad support 310 may be configured to securely engage a thigh 202 of a user 200, as illustrated in FIGS. 8 and 9. The mouse pad assembly 330 of the mouse pad device 300 may be selectively deployable at a selected sloped angle with respect to the pad support 310. The user of the mouse pad device 300 can deploy the mouse pad assembly 330 at the selected angle to achieve optimum ergonomic comfort for the user in dependence of the user's desired body posture.

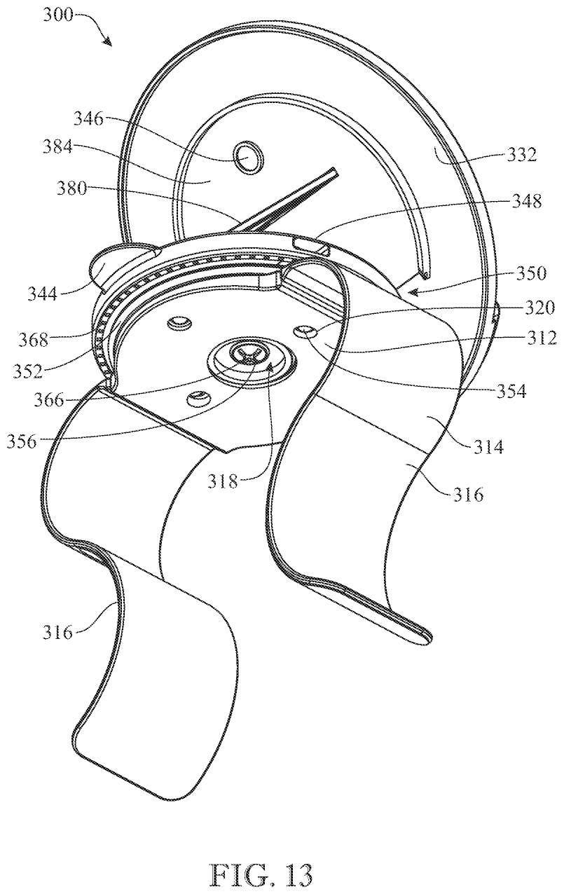

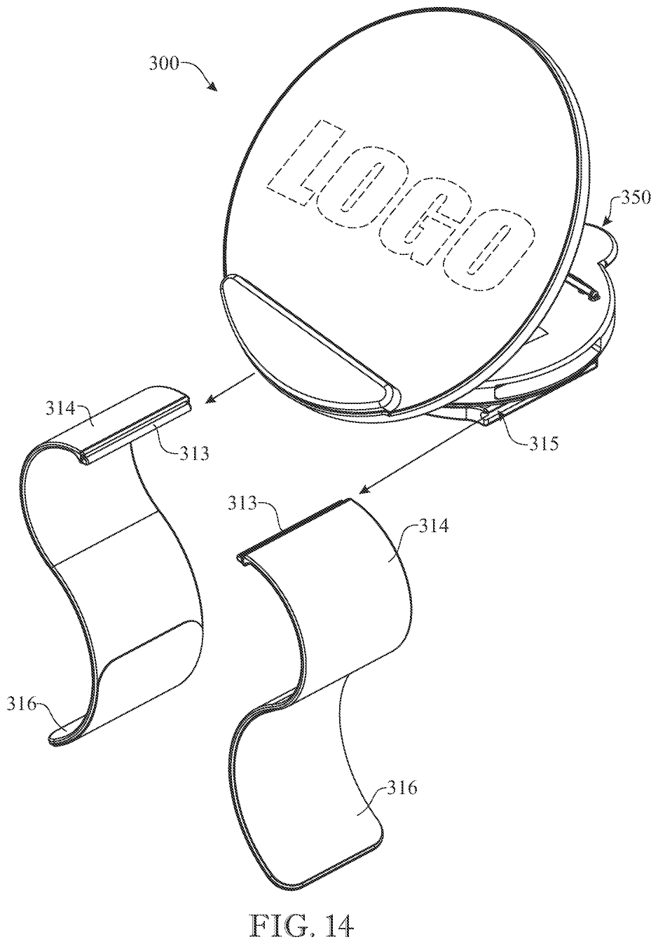

The pad support 310 of the mouse pad device 300 may have any design which is suitable for the purpose of securely engaging the thigh of the user and supporting the mouse pad assembly 330 on the user's thigh. Accordingly, in some embodiments, the pad support 310 may include a central, connecting portion 312 (FIG. 13). One or more elongated, spaced-apart fastening straps 314 may extend from the connecting portion 312 and may be configured to wrap around the user's thigh 202. The one or more fastening straps 314 may include a pair of flexible straps, as shown. The fastening strap or straps 314 may be fabricated of a flexible material such as plastic, silicone, rubber and/or plastic, for example and without limitation. In the present embodiment, and as shown in FIG. 14, each fastening strap 314 is removably attachable and includes a proximal end having a male connecting member 313 along the strap's end. The male end 313 is attachable or otherwise connectable to a corresponding end of the connecting portion 312 of the pad support 310 at a female receiving channel 315. Insertion of the male connecting member 313 to the female receiving channel 315 secures the straps 314 in place until the straps are released from the female receiving channel 315. In one exemplary embodiment, the straps are held in place through magnets or other known retention mechanism known in the art.

With continued reference to FIG. 10, at least one strap fastener 316 may be provided on the interior surfaces of the fastening straps 314, respectively. The strap fasteners 316 may facilitate fastening of the fastening straps 314 around the thigh of the user. In some embodiments, the strap fasteners 316 may include hook-and-loop fasteners, as shown, for example and without limitation. Other types of strap fasteners 316 which may be suitable for the purpose include, but are not limited to, magnets, buttons, snap fasteners, and adhesives.

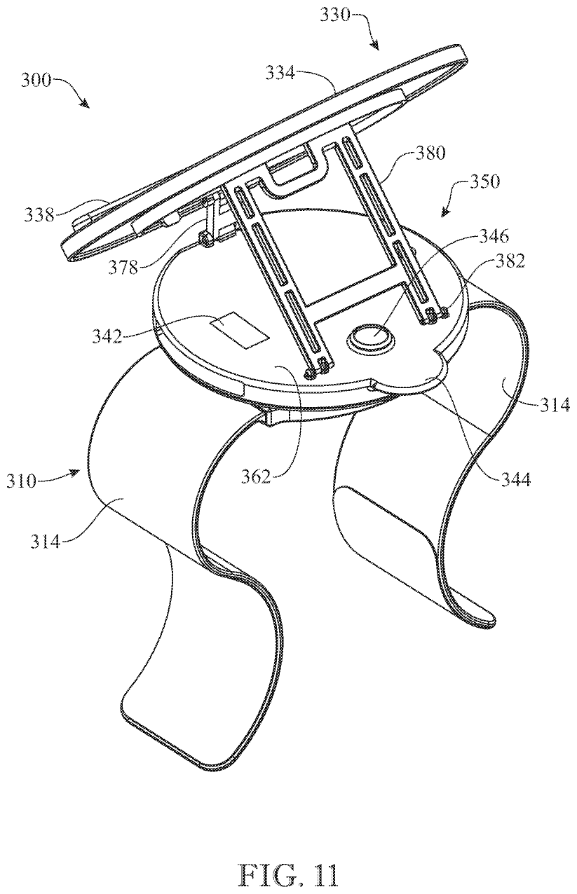

As illustrated in FIGS. 11-13, in some embodiments, the mouse pad assembly 330 may include a bottom pad plate 332. A mouse support layer 334 may be provided on and carried by the bottom pad plate 332. The bottom pad plate 332 of the mouse pad assembly 330 may have a rigid panel construction, thereby providing rigidity and mechanical resistance to the mouse pad assembly 330. For example, and without limitation, in some embodiments, the bottom pad plate 332 may be made of, or include, ABS plastic. In turn, the mouse support layer 334 may be made of one or more soft, skin-friendly and mouse-compatible materials such as, but not limited to, cloth, fabric and/or rubber, to allow the mouse to properly function as it is moved along a top surface 335 of the mouse support layer 334. In some embodiments, at least one protuberance 338 may be provided on the mouse support layer 334. The protuberance 338 may include a foam or foam rubber material, for example and without limitation.

A pad base assembly 350 may attach the mouse pad assembly 330 to the pad support 310. The pad base assembly 350 may include a bottom base plate 352. The bottom base plate 352 of the pad base assembly 350 may be supported by the connecting portion 312 of the pad support 310. A top base plate 362 may be provided on the bottom base plate 352 and include a tab portion 346. The bottom pad plate 332 of the mouse pad assembly 330 may be provided on the top base plate 362. The base plate 362 may also include a rechargeable battery bank therein for storing electrical charge. A backup indicator 342 may be prominently displayed on the upper surface of the base plate 362 and a charging port 348, such as a USB or USB-C port is provided. Accordingly, the battery bank provided in the base plate may be used to charge an external electronic device (not shown) through the charging port 348. The base plate 362 may also include an on/off switch button that turns on/off a daisy-chain of LED lights 168 or the like affixed to a bottom portion proximate the peripheral edge of the bottom base plate 352. To avoid unwanted movement or otherwise restrict the movement of the mouse pad assembly, a magnetic lock 346 is affixed to the base plate 362 and bottom pad plate 332 of the mouse pad assembly 130, locking the pad assembly 330 to the pad base assembly 350. To unlock the pad assembly 330 from the pad base assembly 350 a set amount of opposing force is imposed on each assembly to disengage each pad assembly.

The bottom base plate 352 and the top base plate 362 of the pad base assembly 350 may be attached to the connecting portion 312 of the pad support 310. Accordingly, as illustrated in FIGS. 11-13, a plate mount opening 318 may extend through the connecting portion 312. At least one, and more preferably, a pair of tab openings 320 may extend through the connecting portion 312 of the pad support 310. At least one plate mount tab 354 may extend from the underside or bottom surface of the bottom base plate 352 in alignment or registration with the respective tab openings 320 in the connecting portion 312. The bottom base plate 352 may seat into the plate mount opening 318 as the plate mount tabs 354 on the bottom base plate 352 engage the respective tab openings 320 in the connecting portion 312 of the pad support 310.

With continued reference to FIGS. 11-13, a central plate attachment opening 356 may extend through the bottom base plate 352. An interiorly threaded plate mount boss may extend from the underside or bottom surface of the top base plate 362 in alignment or registration with the plate attachment opening 356 of the bottom base plate 352. A plate fastener 366 may extend through a washer and through the plate mount opening 318 in the connecting portion 312 of the pad support 310 and the plate attachment opening 356 in the bottom base plate 352, respectively, and thread into the plate mount boss on the top base plate 362. The top base plate 362 may be selectively rotatable with respect to the bottom base plate 352 and the pad support 310, via the plate fastener 366.

The top base plate 362 may magnetically engage the bottom base plate 352 of the pad base assembly 350 to magnetically “lock” the top base plate 362 in at least one, and more preferably, multiple different rotational positions relative to the bottom base plate 352. As iterated above, at least one, and more preferably, multiple bottom plate magnet seats 158 may be provided on the upper surface of the bottom base plate 152. At least one, and more preferably, multiple bottom plate magnets 170 may be provided in the respective bottom plate magnet seats 158 (FIG. 2). At least one, and more preferably, a pair of top plate magnet seats 172 may be provided on the lower surface of the top base plate 162 (FIG. 3). At least one, and more preferably, a pair of top plate magnets 174 may be provided in the respective top plate magnet seats 172. Therefore, the top base plate 162 may be capable of indexed rotation with respect to the bottom base plate 152 of the pad base assembly 150 as the top plate magnets 174 on the top base plate 162 magnetically engage the respective bottom plate magnets 170 on the bottom base plate 152.

As illustrated in FIGS. 11-13, the mouse pad assembly 330 may be selectively deployable at a sloped angle relative to the pad base assembly 350 and the pad support 310. Accordingly, at least one hinge 378 may pivotally attach the bottom pad plate 332 of the mouse pad assembly 330 to the top base plate 362 of the pad base assembly 350. At least one plate support 380 may selectively support the mouse pad assembly 330 at the selected angle. In some embodiments, the plate support 380 may be U-shaped and may be pivotally attached to the upper surface of the top base plate 362 via at least one support mount flange 382. The plate support 380 may adjustably engage the bottom pad plate 332 of the mouse pad assembly 330 to facilitate deployment of the mouse pad assembly 330 at the selected sloped angle with respect to the pad base assembly 350.

In summary, the mouse pad device of the present disclosure provides an accessory for use with a computer mouse, tablet or other electronic device, which allows a user to comfortably use the device while allowing the user to sit in a comfortable posture, not requiring to lean forward to manipulate the mouse or other device. For example, and without limitation, the user may rest his or her back on the back of a chair, couch, sofa, etc. while operating the computer mouse on reading from the tablet; this may help prevent back pain and other health issues related to poor body postures, and may contribute to a more pleasant and relaxing experience.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A mouse pad device for supporting a computer mouse, tablet or other electronic device in a comfortable position for the user, the mouse pad device comprising:
a mouse pad assembly, comprising a top surface configured to support and allow operation therealong of a computer mouse; and
a pad support configured to secure the mouse pad assembly to a thigh of a user.

2. The mouse pad device of claim 1, wherein at least one logo, image, pattern, design, text, number, or other informative or decorative element is providable on the top surface of the mouse pad assembly

3. The mouse pad device of claim 1, wherein a pad base assembly is provided on the pad support, and the mouse pad assembly is supported by the pad base assembly.

4. The mouse pad device of claim 3, wherein the pad base assembly includes a bottom base plate and a top base plate that rotates with respect to the bottom base plate.

5. The mouse pad device of claim 1, wherein the pad support includes at least one fastening strap configured to wrap around and attach to the user's thigh.

6. The mouse pad device of claim 5, wherein the at least one fastening strap is a removably attachable fastening strap that includes a male connecting end that connects to a female receiving end provided on the pad support.

7. The mouse pad device of claim 1, wherein the pad support includes at least one fastening strap, and the fastening strap is made out of at least one flexible material.

8. The mouse pad device of claim 4, wherein the top base plate magnetically engages the bottom base plate of the pad base assembly for indexed rotation of the mouse pad assembly with respect to the pad support.

9. The mouse pad device of claim 1, wherein the mouse pad assembly is attached to the pad support, and the mouse pad assembly is deployable at a selected sloped angle with respect to the pad support.

10. The mouse pad device of claim 9, wherein the pad assembly is attached to the pad support through a support hinge.

11. The mouse pad device of claim 1, wherein the mouse pad assembly includes a bottom pad plate and a middle pad plate, and a mouse support layer is provided on the top surface.

12. The mouse pad device of claim 11, wherein the bottom pad plate is made out of a rigid material.

13. The mouse pad device of claim 11, wherein the middle pad plate is made out of a ferromagnetic material,

14. The mouse pad device of claim 11, wherein the mouse support layer is made out of a cloth, fabric, or rubber.

15. The mouse pad device of claim 1, wherein the top surface of the mouse pad assembly includes a protuberance at or adjacent to an edge of a mouse support surface layer.

16. The mouse pad device of claim 1, wherein the pad support includes an interior space retaining an internal battery bank for recharging electronic devices, the internal battery bank connected to a charging port disposed at a peripheral edge of the pad support.

17. The mouse pad device of claim 16, wherein the pad support includes a battery level indicator demonstrating how much charge the internal battery bank has available.

18. The mouse pad device of claim 1, wherein the pad support includes a light source disposed at a bottom surface making contact with the thigh of a user, the light source disposed about a peripheral edge of the pad support and is activated or deactivated through an on/off switch disposed at an upper portion of the pad support.

19. A mouse pad device for supporting a computer mouse, tablet or other electronic device in a comfortable position for the user, the mouse pad device comprising:
a mouse pad assembly, comprising a top surface configured to support and allow operation therealong of a computer mouse; and
a pad support including at least one fastening strap configured to secure the mouse pad assembly to a thigh of a user,
wherein the mouse pad assembly is hingeably attached to the pad support, and the mouse pad assembly is deployable at a selected sloped angle with respect to the pad support; and
wherein the at least one fastening strap is a removably attachable fastening strap that includes a male connecting end that connects to a female receiving end provided on the pad support.

20. A mouse pad device for supporting a computer mouse, tablet or other electronic device in a comfortable position for the user, the mouse pad device comprising:
a mouse pad assembly, comprising a top surface configured to support and allow operation therealong of a computer mouse;
a pad support configured to secure the mouse pad assembly to a thigh of a user, the pad support including a removable strap, an interior space for retaining an internal battery bank for recharging electronic devices, a battery level indicator demonstrating how much charge the internal battery bank has available, and a light source disposed at a bottom surface about a peripheral bottom edge of the pad support; and
a magnetic locking mechanism disposed on the pad support and mouse pad assembly for locking the pad support and mouse pad assembly together;
wherein the light source is activated or deactivated through an on/off switch disposed at an upper portion of the pad support,
wherein the mouse pad assembly is hingeably attached to the pad support, and the mouse pad assembly is deployable at a selected sloped angle with respect to the pad support, and
wherein the internal battery bank includes an accessible charging port disposed at a peripheral edge of the pad support.
